(19) United States
(12) Patent Application Publication
(10) Pub. No.: US 2024/0375531 A1
(43) Pub. Date: Nov. 14, 2024

(54) CHARGING SOCKET, PLUG CONNECTOR, AND SYSTEM OF CHARGING SOCKET AND PLUG CONNECTOR FOR HIGH-VOLTAGE APPLICATIONS

(71) Applicant: Auto-Kabel Management GmbH, Hausen i.W. (DE)

(72) Inventors: Matthias Weinbrich, Dorsten (DE); Gordon Kraft, Viersen (DE)

(21) Appl. No.: 18/687,115

(22) PCT Filed: Aug. 16, 2022
(86) PCT No.: PCT/EP2022/072836

§ 371 Date: Feb. 27, 2024

(30) Foreign Application Priority Data
Sep. 10, 2021 (DE) 10 2021 123 486.7

(51) Int. Cl. B60L 53/16; H01R 13/03; H01R 13/04; H01R 13/10; H01R 13/207

(52) U.S. Cl. CPC B60L 53/16; H01R 13/03; H01R 13/04; H01R 13/10; H01R 13/207; H01R 2201/26

(57) ABSTRACT

The invention relates to a charging socket, a plug connector and a system of charging socket and plug connector for high-voltage applications, wherein in particular the plug connector comprises at least two plug-in pins which have in each case two regions. A first region has a greater cross-section than a second region. The first region has a recess at the front face of the first region.

The subject matter relates to a charging socket, a plug connector and a power transmission system for high-voltage applications.

One of the biggest challenges of the electrification of automobility lies in minimizing the charging times of the energy stores involved. The tank of a conventional vehicle with a combustion engine is filled with fuel within a few minutes, containing enough energy to drive hundreds of kilometers. The situation is different for electrically powered vehicles, however, where an electric accumulator with a high capacity usually has to be charged at a charging station. High currents and voltages are used to charge the accumulator as quickly as possible, preferably significantly faster than it is subsequently discharged during driving operation.

In order to transfer the necessary high charging power from the charging station to the vehicle accumulator, the entire transmission path from the charging station socket via the vehicle socket to the accumulator must have very good electrical conductivity. In particular, all transitions between the individual components of the transmission path must have particularly low contact resistances.

Another challenge relates to a lack of standardization and/or the ongoing further development of plug geometries for charging stations and plugs thereof. In particular, the distances between individual contacts, particularly between the contacts that carry particularly high power, may deviate from today's standards in the future.

The object of the invention was therefore, inter alia, to provide a particularly conductive and adaptable transition between a charging socket and an energy conductor on the vehicle.

This object is achieved by a plug connector according to claim 1, a charging socket according to claim 29, and a system according to claim 31.

One aspect relates to a plug connector. The plug connector can be part of a charging socket and/or be formed on its own. The plug connector can be arranged at least partially in a receptacle of a charging socket.

In particular, the plug connector can be at least partially electrically conductive.

The plug connector comprises at least one plug-in pin made of an electrically conductive material, in particular a metal material. The plug-in pin can be arranged in the plug connector. Parts of the plug connector can at least partially enclose the plug-in pin.

Parts of the at least one plug-in pin are arranged in the receptacle. The plug-in pin, in particular a part of the plug-in pin, can serve as a contact pin for a charging plug. The charging plug can make contact with at least one of the at least one plug-in pin when it is inserted into the receptacle. For example, the plug-in pin can serve as a contact pin for, for example, a control line, alternating current line, direct current line or other type of line.

For example, at least one plug-in pin of the plug connector can be passed at least partially through the rear wall of the receptacle into the receptacle, in particular through an opening in the rear wall.

The receptacle, in particular the shape of the housing and/or the arrangement of the at least one plug-in pin within the receptacle, can be adapted to a plug face of the charging plug. The receptacle can therefore be suitable for a specific type of charging plug.

The charging socket can have a connector receptacle, which can be arranged particularly on the back of the charging socket. The plug connector receptacle can be suitable for inserting the plug connector. The plug connector receptacle can comprise a recess in the charging socket, in particular in the housing of the charging socket. In particular, the plug connector receptacle can be at least partially substantially cross-sectionally adapted to a plug connector.

In particular, the plug connector receptacle can also comprise a collar. A collar can, for example, protrude beyond the rest of the charging socket in the region of the rear, in particular beyond the remaining housing wall of the housing of the charging socket.

The charging socket can also comprise a bearing surface for the plug connector. The plug connector can rest at least partially on the bearing surface. The bearing surface can be arranged on the housing of the charging socket, for example. The contact surface can, for example, be arranged around the plug-in pins and/or around the plug connector receptacle. The bearing surface can also be arranged at least partially on the collar.

Retaining means for the plug connector can be provided on the charging socket, for example form-fit and/or force-fit cooling means, for example hooks, threads for screws, in particular threads embedded in the housing of the charging socket, in particular made of a metal material, or similar retaining means. In particular, the retaining means can be arranged in the region of the plug connector receptacle, for example in the plug connector receptacle or in a region around the plug connector receptacle. The retaining means can be used to connect a plug connector to the charging socket. For example, this can be fastened to the charging socket by means of at least one, preferably two, three or four or more screws.

In particular, the plug connector can be connected to the charging socket in a force-fit and/or form-fit manner.

At least one seal can be arranged on at least parts of the plug connector receptacle and/or the bearing surface. For example, the seal can be arranged in a closed shape, for example in a ring, rectangle, oval or other closed shape on the plug connector receptacle and/or the bearing surface. The seal can enclose at least part of the plug connector receptacle. The seal can, for example, be made of an elastic material, in particular plastic, rubber, silicone or similar materials. Such a seal can be arranged on the plug connector.

The plug connector of the subject matter comprises a housing. The housing can be made of a non-conductive material. For example, the housing can be molded from a plastic, in particular a plastic that is suitable for high temperatures and/or has a high thermal conductivity. For example, polyamidimide, polysulfone, polyethersulfone, PA6GF15, UL94 or a similar heat-resistant plastic can be used. The housing can also be at least partially formed from other non-conductive materials such as ceramic or glass.

The housing of the plug connector and/or the housing of the charging socket can be formed in one piece, for example molded and/or injection-molded. It is also possible that the housing is made up of several parts. The individual parts can, for example, be screwed, glued, welded or fastened to one another and/or other elements in some other manner.

Any seals arranged on the plug connector and/or the charging socket can, for example, be produced in a two-component injection molding process together with other parts of the respective housing. Seals can also be arranged as separate components on the housing.

Furthermore, the plug connector of the subject matter comprises at least one plug-in pin.

A longitudinal axis can be defined for a plug-in pin. In particular, the longitudinal axis extends substantially along the direction of the greatest spatial extension of the plug-in pin.

The plug-in pin of the subject matter comprises at least two opposing front faces. These can be substantially flat. It is also possible to have a surface of at least one of the front faces that deviates from a flat shape, for example a rounded shape, a pointed shape, for example a cone-shaped or a saddle roof-shaped pointing or another surface shape of the front faces.

A front face can represent the end of the plug-in pin along the longitudinal axis. Part of the plug-in pin can also protrude beyond the front face.

For example, a guide tip can protrude beyond a front face of the plug-in pin. A guide tip can extend beyond the front face in the direction of the longitudinal axis of the plug-in pin. The guide tip has a smaller diameter than the region of the plug-in pin on the side of the front face facing away from the guide tip. In particular, the guide tip may have a protrusion, in particular a thickening and/or an indentation, in particular a circumferential thickening and/or indentation. A thickening and/or indentation can be used to fasten an element to the guide tip.

In particular, a cap made of a non-conductive material can be arranged on the plug-in pin, especially on its face side, particularly on the guide tip. In particular, this can be arranged in a force-fit and/or form-fit manner on the plug-in pin, particularly on the guide tip. In particular, an indentation and/or thickening of the guide tip can engage in a thickening and/or indentation of the cap. The cap can be made of plastic, silicone and/or another non-conductive material, for example. In particular, the cap can have substantially the same cross-section, at least in the transition to the plug-in pin, as the region of the plug-in pin adjacent to the cap. This prevents an edge at the transition between the cap and plug-in pin. The cap may also have a smaller cross-section than the second region of the plug-in pin in the region of the plug-in pin adjacent to the cap. The front face of the cap facing away from the plug-in pin can be substantially flat; a rounded shape of the front face can also be provided.

The cross-section of a region of the plug-in pin is in particular a section perpendicular to the longitudinal axis of the plug-in pin and/or perpendicular to the longitudinal axis of the respective region of the plug-in pin whose cross-section is being determined.

Starting from a first front face of the plug-in pin, a first region of the plug-in pin extends to a center region of the plug-in pin. Starting from a second front face opposite the first front face, a second region of the plug-in pin extends to the center region of the plug-in pin.

In particular, the guide tip can be arranged on the second region, especially on the second front face.

In the charging socket, the plug-in pin extends from the rear of the charging socket into the receptacle for the charging plug. In particular, the first region extends from the rear in the direction of the receptacle. The second region extends at least partially into the receptacle. Thus, the second region in particular can at least partially serve as a contact pin for a charging plug.

The center region of the plug-in pin can have an extension in the longitudinal direction of the plug-in pin. The center region can comprise parts of the first and/or second region. The center region can also define a further region of the plug-in pin that is different from the first and second regions. The center region can be substantially halfway along the longitudinal axis of the plug-in pin. The center region can also be arranged further away from one of the front faces than from the other front face.

The first region of the plug-in pin can have a further front face in addition to the first front face. This further front face can be oriented substantially away from the first front face. The other front face points in the direction of the second region. The further front face can be substantially flat in shape. It is also possible to have a surface of the further front face that deviates from a flat shape, for example a rounded shape, a pointed shape, in particular a cone-shaped, stepped and/or saddle roof-shaped pointing or another surface shape of the further front face.

The cross-section of the first region can be larger than the cross-section of the second region. The cross-section is to be determined substantially perpendicular to the longitudinal extension of the plug-in pin. A larger cross-section is associated with an increased material volume, among other things, and thus with an increased thermal capacity of the plug-in pin.

If a first cross-section is indicated as being larger than a second cross-section, this may mean that the cross-sectional surface of the first cross-section is larger than the cross-sectional surface of the second cross-section. This can mean that the first cross-section has a larger diameter in at least one direction than the second cross-section. It can also mean that the first cross-section can completely envelop the second cross-section.

A plug-in direction can be defined for a plug-in pin. This can, in particular, be defined substantially parallel to the longitudinal axis of the plug-in pin and extend from the first region to the second region of the plug-in pin.

A recess is arranged in the first front face of the plug-in pin. This can be used to accommodate a connection pin. The recess can extend parallel to the longitudinal axis of the plug-in pin in the direction of the center region of the plug-in pin. The recess can have a substantially round cross-section; but the cross-section can also be elliptical, angular, in particular triangular, quadrangular, pentagonal or polygonal in shape.

The cross-section of the recess can be substantially constant along the longitudinal axis. The cross-section can also taper, in particular along the longitudinal axis in the direction of the center region of the plug-in pin, in particular linearly, so that the cross-section decreases linearly with increasing penetration depth of the recess into the first region of the plug connector. The cross-section of a recess can decrease evenly on all sides perpendicular to the direction in which the recess extends, for example perpendicular to the longitudinal axis of the plug-in pin. The cross-section can also decrease more in one direction perpendicular to the longitudinal axis than in another direction. In particular, an asymmetry of the recess can be achieved in this manner, which allows the insertion of a correspondingly shaped pin only in an angular position around the longitudinal axis of the plug-in pin. In a preferred embodiment, the recess is conical in shape.

The plug connector can comprise a single plug-in pin. The plug connector can also comprise at least two plug-in pins.

The at least two plug-in pins can be arranged substantially parallel to one another in the plug connector. The plug-in directions of the at least two plug-in pins can point in the same direction.

The plug-in pins of the plug connector can be fixed in the housing. In particular, the plug-in pins can be fixed in such a way that the longitudinal axes of at least two plug-in pins are substantially parallel to one another. The housing can fix the plug-in pins in such a way that they cannot move relative to one another without deforming and/or damaging the housing.

The housing can at least partially enclose the plug-in pins. Preferably, those surfaces of the plug-in pins that are used for contacting other conductive elements remain free of housing parts.

A center axis can be defined for a region of the plug-in pin of the subject matter. This can, for example, extend parallel to the longitudinal axis of the plug-in pin. In particular, the center axis may extend through a center and/or near a center of at least part of the cross-sections of the respective region of the plug-in pin. The cross-section here is a section perpendicular to the longitudinal axis of the plug-in pin and/or perpendicular to the longitudinal axis of the respective region of the plug-in pin whose cross-section is being determined. For example, the center of the cross-section can be defined as the geometric center of mass of the cross-section.

A center axis can be defined for the first region and also for the second region of the plug-in pin.

The second region can be centrally connected to the first region. For example, the center axes of the first region and the second region may substantially coincide. The second region can also be arranged eccentrically on the first region. This can mean, for example, that the center axis of the second region is spaced apart from the center axis of the first region, in particular is spaced apart perpendicular to the center axis of at least one of the regions and/or perpendicular to the longitudinal axis of the plug-in pin and/or one of the regions of the plug-in pin.

Due to an eccentric arrangement of the second region on the first region of the plug-in pin, it is possible, particularly in an arrangement comprising two or more plug-in pins, for the center axes of the first regions to be further apart than the center axes of the second regions. The central axes of the second regions can also be further apart than the central axes of the first regions.

A distance between two axes, particularly center axes, can be defined as the shortest possible connection between two axes.

The center axes of the second regions of at least two plug-in pins can both be spaced apart from the center axis of the first region of the respective plug-in pin. Also, only the second region of one of the plug-in pins may be arranged eccentrically on the first region of the plug-in pin, while the other plug-in pin or pins have a first and second region each with substantially the same central axis.

Due to the eccentric arrangement of the second regions of the at least two plug-in pins, the second regions of the plug-in pins can approximate one another while maintaining the same distance between the first regions. The second regions can also be spaced apart from one another by the eccentric arrangement. With a given connector face, the smaller distance between the center axes of the second regions compared to the distance between the center axes of the first regions means that heat can be dissipated as well as possible via the first regions. The spacing of the first regions leads to a low accumulation of heat between the stack pins. The recesses of the first regions can also be spaced apart as far apart as possible, which further leads to a spatial distribution of warm elements.

The center axes of the first regions and the second regions of the at least two plug-in pins can lie substantially in a common plane.

The center axes of the second regions can be at a smaller distance from one another than the center axes of the first regions of the at least two plug-in pins.

The central axis of the first region and that of the second region can be parallel to one another. The two center axes can also be tilted against one another.

An eccentric arrangement of the second region on the first region enables not only better heat dissipation and stress resistance, but in particular also a relative positioning of the center axes of the two regions (of the first and second) to one another. In particular, part of an adaptation between two different plug-in geometries can be achieved in this manner. One plug-in geometry can be connected on the side of the second regions, another on the side of the first region of the plug-in pins. An eccentric arrangement can compensate for different distances between connection points on the sides of the first region and the second region.

The geometric spacing within the plug connector can also be influenced by the eccentric arrangement of the second region on the first region. By means of the eccentric arrangement of the second region on the first region, the second region of a first plug-in pin can be moved closer to or away from at least one other plug-in pin without changing the relative position of the first regions of the plug-in pins with respect to one another. The same applies vice versa for the position of the second regions of the plug-in pins. The second region of a first plug-in pin can, for example, be spaced apart as far as possible from the second plug-in pin, in particular from the second region of the second plug-in pin, by means of an eccentric arrangement. The second region of a first plug-in pin can also be brought as close as possible to the at least one other plug-in pin of the plug connector.

Similarly, it is possible to vary the distance of the first regions from one another by the eccentric arrangement of the second region on the first region while keeping the distance between the first regions substantially constant. The first regions can also be approximated or spaced out in this manner.

In a preferred embodiment, the second regions of the at least two plug-in pins are each arranged eccentrically in the direction of the other plug-in pin(s). In this manner, the first regions are spaced apart as far apart as possible, given the distance between the second regions. In other words, for a given distance between the first regions, the second regions are as close together as possible.

The at least two plug-in pins are spaced apart from one another in the plug connector. In particular, the plug-in pins are spaced apart from one another substantially perpendicular to the longitudinal axis of at least one of the plug-in pins.

The longitudinal axes of the plug-in pins are substantially parallel to one another. The plug-in directions of the plug-in pins can also be substantially parallel to one another. The plug-in directions and/or longitudinal axes can also be tilted in relation to one another.

The recess in the first region of a plug-in pin can also be arranged eccentrically to the center axis of the first region in the first region of the plug-in pin. In this way, similar to the eccentric positioning of the second region on the first region, an adaptation to a predetermined distance of connection pins can be achieved. The distance between any elements positioned in the recess can also be adjusted. In particular, the recess of at least one plug-in pin can be offset eccentrically outwards in the first region, so that it is at a greater distance from another plug-in pin of the plug connector than it would be in a central arrangement.

The recess and the second region can be offset in substantially the same direction relative to the central axis of the first region. These two can also be offset in different directions, particularly in opposite directions. For example, the second region of a plug-in pin can be approximated to another plug-in pin of the plug connector by its eccentric arrangement on the first region, while the recess is spaced apart from the other plug-in pin by its eccentric arrangement on the first region of the plug-in pin.

The first and/or the second front faces of the plug-in pins can be substantially flush with one another in the longitudinal direction. The front faces can therefore be aligned with one another in a direction perpendicular to the longitudinal axis, center axis and/or plug-in direction of at least one of the plug-in pins. The plug-in pins can also be offset from one another along the longitudinal axis.

In particular, the plug-in pins can be of the same length. Different lengths are also possible. For example, the first regions of at least two plug-in pins may have different lengths, in particular such that the recesses are offset from one another along the longitudinal axis, while at least some of the remaining regions of the plug-in pins, for example the second front faces, are not offset from one another along the longitudinal axis.

The second region is adjacent to another front face of the first region, which is different from the first front face. The other front face is arranged in the center region of the plug-in pin. The front face can be substantially smooth. The edges of the further front face can also be rounded and/or flattened, for example. The further front face can also taper towards the second region, for example, in particular in the shape of a cone.

The second region of at least one of the plug-in pins can be shaped as a pin. The second region' may, for example, have at least partially a round cross-section, an oval, elliptical, angular, in particular triangular, quadrangular, polygonal or otherwise shaped cross-section. The cross-section of the second region can be substantially constant along the longitudinal axis. The cross-section of the second region can also vary. In particular, the cross-section of the second region can increase, for example in steps, towards the center region, in particular in the center region.

In particular, the cross-section of the second region can therefore have an increased cross-section in the center region, in the transition to the first region. This increases the mechanical stability of the transition. An indentation, for example a circumferential groove, can also be provided in the center region. In particular, a seal, for example a sealing ring, can be provided around the second region, in particular in the region of the increased cross-section, in particular in the circumferential groove.

A guide tip can be arranged on the face side of the second region as described above.

The plug-in pins are made of a conductive material. In particular, the plug-in pins can be formed from a metallic material. For example, a plug-in pin may be formed at least in part from copper, aluminum, iron, gold, silver or other metal materials and/or alloys thereof.

It can be advantageous to at least partially coat plug-in pins.

In particular, a metallic coating can be advantageous, for example to prevent contact corrosion, reduce contact resistance and/or make the plug connector more durable. For example, a plug-in pin can be coated with silver, gold, copper, aluminum, nickel and/or other metals and/or alloys thereof. The coating can substantially cover the entire plug-in pin or only be applied to selected regions. For example, a coating can be applied in the recess and/or on the second region of the plug-in pin. It is also possible to provide a plug-in pin with a double coating, for example with an inner nickel layer and an outer silver layer.

In a preferred embodiment, at least one plug-in pin is formed from copper, in particular E-copper. The copper can be coated with silver, in particular with sub-nickel-plated silver.

The surface of the first region can be substantially smooth. The surface of the first region can also be textured. For example, the first region may have protrusions and/or indentations, in particular at least one groove, in particular an at least partially circumferential groove. In particular, the lateral surface of the first region may be structured. For example, this can have at least one at least partially circumferential groove. In addition to the first front face and the further front face of the first region, the lateral surface is a further surface that extends in particular around the longitudinal axis. A textured surface has the advantage of increased connection strength between the plug-in pin and the housing.

The cross-section of the first region and/or the second region can be substantially constant along the longitudinal axis of the plug-in pin. Minor deviations, for example due to surface structuring, are included.

To ensure that the plug-in pin has a good hold in the housing and, in particular, is protected against rotation about the longitudinal axis relative to the housing, it can be advantageous to design the cross-section of the first region to deviate from a round shape. In particular, the first region may have at least one indentation and/or one protrusion extending at least partially along the longitudinal direction. For example, a groove can be provided or a strip. Other protrusions such as individual rod-shaped protrusions and/or pot-shaped indentations are also possible. In particular, the cross-section can also be angular in shape, for example triangular, quadrangular, pentagonal, polygonal, and/or star-shaped or otherwise shaped. Due to the fact that the cross-section is not rotationally symmetrical, at least in some regions, a twist would be accompanied by a change in the cross-section. This allows the housing to effectively counteract twisting.

In one embodiment, the cross-section of the first region of a first plug-in pin may be flattened towards the side of the first region which faces the at least one other plug-in pin in the assembled state.

The prevention of twisting is particularly important in the case of eccentrically arranged recesses in first regions and/or eccentric arrangement of second regions on first regions. A twist would change the connection geometry and in particular the distance between individual connections such as the second regions of the plug-in pins and/or the recesses in the first regions of the plug-in pins.

A blind hole can be provided in the recess of at least one of the plug-in pins. In particular, a thread can be provided in the blind hole. The blind hole can end in the first region. It is also possible in some cases for the blind hole to protrude into the second region. The blind hole, particularly with a thread, enables a connection pin to be firmly screwed into the recess. A high contact pressure between pin and recess can be achieved. This allows a particularly low-resistance transition to be created between a connection pin and the plug-in pin.

In particular in combination with a tapered, in particular conical recess, a connection pin, which is also tapered and in particular conical, can be permanently connected in the recess by means of the thread in the blind hole and a screw in a firm and well-conducting manner.

The plug-in pin can be formed in one piece. It is also possible for the plug-in pin to be produced from several, in particular two, partial pieces. For example, one partial piece may substantially correspond to the first region and one partial piece may substantially correspond to the second region.

In one embodiment, the at least two plug-in pins of the plug connector are substantially identical in shape. In another embodiment, the plug-in pins are mirror-symmetrical to one another.

The housing fixes the at least two plug-in pins to one another. For this purpose, the housing at least partially encloses the plug-in pins. In particular, the housing can engage with the outer lateral surfaces of the first regions of the plug-in pins. The lateral surfaces of the first regions provide a large access surface for the housing. Since the first region is preferably in contact with another current-carrying element via the recess, the lateral surface also does not fulfill an electrically conductive function and can be covered with the housing. In addition to mechanically fixing the plug-in pins, this also serves to electrically insulate the first region. In particular, the housing serves to electrically insulate the plug-in pins from one another.

The housing can be made of a non-conductive material, in particular ceramic, glass and/or plastic. Preferably, a high-temperature plastic can be used. The housing can be formed in one piece. The housing can also be made up of several parts. The housing and/or its parts may be substantially rigid and substantially unchangeable in shape. It is also possible for the housing and/or its parts to be flexible. In particular, it is possible for several parts of the housing to be connected to one another in a movable and/or captive manner, for example by hinges.

The housing can be connected with the plug-in pins. For example, the plug-in pins can be inserted into the housing at recesses provided for this purpose. For this purpose, retaining means can be provided on the housing, for example protrusions on at least part of the edges of the openings in the recesses of the housing. It is also possible for the housing to be placed around the plug-in pins in a multi-part design. For example, several parts of the housing can be placed around the plug-in pins and can be connected to one another. For example, the parts can be screwed together. Retaining means on housing parts, such as recesses and barbs, which can interlock to connect the housing parts, are also possible.

Retaining means can be provided for fastening the plug-in pins in the housing. Examples of protrusions at the edges of the openings in the recesses of the housing have already been mentioned above. Other possibilities comprise protrusions, for example within the recess for the plug-in pins, which can engage in protrusions provided on the lateral surface of the first regions of the plug-in pins. Conversely, protrusions on the housing can engage in recesses on the lateral surfaces of the first regions of the plug-in pins.

In a preferred embodiment, the housing around the plug-in pins can be injection molded, cast or otherwise converted from a malleable consistency to a rigid consistency in direct contact with the plug-in pins. In particular, a plastic housing can be molded around the plug-in pins. Hardening the housing around the plug-in pins has the advantage that the housing fits snugly against the plug-in pins, in particular against the lateral surfaces of the first regions of the plug-in pins. This not only ensures a good hold, but also high thermal conductivity in the housing and thus a good ability to dissipate heat. A very stable connection can be achieved, particularly if the surface of the plug-in pins is textured in the regions, especially protrusions and/or indentations, where the housing is applied to the plug-in pins.

The housing preferably rests substantially over the entire surface of the lateral surfaces of the first regions of the plug-in pins. There is therefore direct contact between the housing and the plug-in pin over a large part of the overlap between the housing and the plug-in pin. In particular, the housing can engage in indentations on the plug-in pin, in particular on the lateral surface of the first region of the plug-in pin, for example grooves. Protrusions on the surface of the plug-in pin also engage in indentations in the housing.

In particular, full-surface contact of the housing on the plug-in pins, in particular on the lateral surfaces of the first regions of the plug-in pins, can be achieved if the housing is molded, injection-molded or otherwise formed around the plug-in pins.

The housing of the plug connector may have openings, as already mentioned above. These at least enable contact to be made with the recess in the front face of the first region of at least the plug-in pins. In one embodiment, the housing has an opening in the region of the first front face of at least one of the plug-in pins. In particular, the first front face can be completely exposed by an opening in the housing. In one embodiment, the housing is substantially flush with the first front face of at least one plug-in pin. It is also possible for the housing to protrude beyond the first front face in the longitudinal direction. The first front face can also be substantially completely covered by the housing, so that only the access for receiving at least one plug-in pin remains. This can have the advantage that few conductive surfaces are openly accessible in the receptacle after connecting a connection pin.

An opening must also be provided in the housing, which allows at least parts of the second region of the plug-in pins to make contact. The housing can have an opening for at least one, preferably for all plug-in pins on the side of the housing opposite the first front face and/or the respective plug-in pin. This allows the second region of the plug-in pin to be contacted. As already shown above, a further front face of the first region can be identified, which is different from the first front face of the plug-in pin. This is a front face which faces the second region of the respective plug-in pin to which the first region belongs. In some embodiments of the housing, this further front face is also at least partially exposed through an opening in the housing. In particular, the housing can be substantially flush with the further front face of the first region. It is also possible for the housing to extend at least partially beyond the further front face in the longitudinal direction in the direction of the second region. It is also possible to cover the further front face of the first region substantially completely with the housing.

The housing of the plug connector can designed in an all solid manner. It is also possible that the housing has open spaces. This saves material and weight and minimizes the heat transfer path from the plug-in pins to the environment, while increasing the surface area of the housing. The housing surfaces that are in direct contact with the surroundings can serve as cooling surfaces. In particular, frame surfaces can be provided on the housing to support an otherwise minimal housing. For example, the plug-in pins can each be enclosed by only one housing layer on their surface areas to be enclosed. However, this alone would probably not provide sufficient stability for the housing. In addition, frame surfaces can be provided on the housing to stabilize the housing, among other things. The frame surfaces can be part of the housing; in particular, the housing can be formed integrally with frame surfaces. It is also possible to fasten the frame surfaces to the other housing parts, for example by gluing, welding, screwing and/or other means.

Frame surfaces can be formed from the same material as the housing. It is also possible to produce frame surfaces from a different material. For example, frame surfaces can be formed from a material with good thermal conductivity, such as a metal material. In addition to a high level of stability, this can achieve a particularly high ability to dissipate heat, for example by means of heat radiation.

Frame surfaces may be substantially flat and have substantially a single orientation. It is also possible to vary the spatial orientation of frame surfaces locally. For example, frame surfaces can be wave-shaped, zig-zag shaped, irregularly variable in their orientation or otherwise shaped differently from a flat surface.

In one embodiment, frame surfaces can be oriented substantially perpendicular to the longitudinal axis of the at least one plug-in pin. In addition or alternatively, frame surfaces can be aligned parallel to the longitudinal axis, for example in one or two surface orientations, which are perpendicular to one another, for example. Several frame surfaces can be provided. Frame surfaces can have different orientations and/or shapes.

At least one frame surface can protrude beyond the rest of the housing perpendicular to the longitudinal axis of the plug-in pins. In particular, this can be at least one frame surface which is itself substantially perpendicular to the longitudinal axis of at least one of the plug-in pins. Holes can be arranged in the frame surface. For example, two, three, four or more holes can be arranged in the frame surface. In particular, the holes can be arranged in a region of the frame surface that protrudes beyond the rest of the housing. For example, screws, rivets, barbs or other fastening means can be passed through the holes, which can be used to fasten the plug connector to another element. The holes can be at least partially reinforced, for example with metal inserts.

The plug connector can be used, for example, as a translating adapter with a particularly high current carrying capacity and the possibility of heat dissipation and heat capacity in a charging socket.

In particular, at least one seal can be arranged on a frame element. For example, a seal can be arranged on a frame surface that makes contact with the charging socket. For example, a seal can be arranged around the plug-in pins. In particular, a seal can be arranged on at least one or more frame surfaces which project beyond the housing perpendicular to the longitudinal axis of the plug-in pins. For example, a seal can be formed from an elastic material such as silicone, plastic, rubber or another sealing material. In particular, sealing materials that are heat-resistant and/or fireproof and/or have high thermal conductivity are preferable.

As already mentioned above, the housing can project beyond the further front face of the first region of at least one plug-in pin, which points in the direction of the second region, in particular in the direction of the second region. In particular, a frame surface can project beyond the further front face in the direction of the second region. For example, the frame surface can be arranged between the at least two plug-in pins. In particular, the frame surface can be arranged substantially parallel to the longitudinal direction of at least one of the plug-in pins. The frame surface designed in this way can serve to insulate the plug-in pins from one another in the region of the second region. Arcing and leakage currents are less likely. The frame surface of this type can also serve as a spacer with respect to further elements which approximate the further front face of the first region from the direction of the second region. The frame surface can project longitudinally beyond the rest of the housing. The frame surface may serve to insulate the at least two plug-in pins from one another, in particular to increase the path of a leakage current between the plug-in pins, in particular along a surface of the housing.

Another aspect relates to a charging socket. The charging socket of the subject matter comprises a front side and a rear side facing away from the front side. Both the front side and rear side can be associated with the surfaces of the charging socket. Both the front side and rear side of the charging socket can also be defined as spatial regions detached from structural units of the charging socket.

The charging socket of the subject matter comprises at least one receptacle for a charging plug. The receptacle is located at the front side. The charging plug can come from a charging station, for example. It can be a mode 2, mode 3, type 1 or type 2 plug, for example. In particular, the plug can have connections for charging via direct current. For example, the plug can be a Combined Charging System (CCS), CHAdeMO, a Tesla® Supercharger plug or another plug with direct current contacts.

The receptacle can be adapted to the plug and, in particular, contain a suitable spatial arrangement of contact pins, which can be shaped as pins. The shape of the receptacle can also be adapted to the charging plug, for example with an adapted cross-section.

The charging socket can comprise a housing. The housing of the charging socket can be formed from a non-conductive material, for example plastic, for example high-temperature plastic, for example a gas-fiber-reinforced plastic, for example PA6GF15, UL94. Materials such as ceramic, glass or similar are also possible.

Fastening means can be provided on the housing, for example force-fit and/or form-fit fastening means, such as holes for screws, snap elements, hooks or similar fastening means. The fastening means can be used to fasten the charging socket to a vehicle, in particular to an electric vehicle.

The receptacle for the charging plug comprises, for example, a recess in the charging socket, in particular in the housing of the charging socket, into which the charging plug can be inserted. The receptacle can be adapted to the cross-section of a charging plug. A closure may also be provided on the receptacle, in particular an openable closure. For example, a flap can close the receptacle for the charging plug. For example, the closure can close automatically, for example spring-loaded, so that the receptacle is closed without the charging plug being inserted.

In some embodiments, the receptacle may have a rear wall. The rear wall can limit the receptacle towards the housing in the direction in which the charging plug is inserted. At least one opening may be provided in the receptacle, in particular in the housing of the receptacle. For example, the opening may have a seal, in particular a circumferential seal. The seal can ensure that the transition between an element guided through the opening, for example a pin or other elements, and the opening is gas-, liquid-and/or pressure-tight. In particular, two or more openings can also be provided in the rear wall.

Further features of the charging socket are explained below. First, another aspect of the subject matter is considered.

Another aspect relates to a system according to claim 32.

The system comprises a charging socket of the subject matter. This can be connected to a plug connector of the subject matter. In particular, the plug connector can be arranged at least partially in the charging socket, in particular in the plug connector receptacle of the charging socket. In particular, the plug connector can be arranged in the charging socket in such a way that at least one of the at least two second regions of the plug-in pins is arranged at least partially in the receptacle of the charging socket. In particular, the plug connector can be in contact with the charging socket around at least one of the plug-in pins, for example on a contact region of the charging socket. The housing of the plug connector can make direct contact with the charging socket and/or a seal can be arranged between the two, via which the plug connector makes indirect contact with the charging socket. The charging socket and connection plug can be connected to one another by force-fit and/or form-fit. In particular, the housing of the plug connector can be connected to the charging socket, in particular to the housing of the charging socket. In particular, the two can be screwed together.

The charging socket of the subject matter, the plug connector of the subject matter and/or the system of the subject matter may be suitable for being connected to a connection part. The connection part can be arranged on the rear side of the charging socket, for example. The connection part can also be arranged at least partially inside the charging socket.

The connection part comprises at least one busbar. In particular, the busbar has a substantially rectangular cross-section. The cross-section may have two wide sides that are opposite and substantially parallel to one another and two narrow sides that are substantially perpendicular to one another and substantially parallel and opposite to one another. The busbar has at least partially a longitudinal axis which is substantially perpendicular to both the narrow and wide sides. The wide side is wider perpendicular to the longitudinal axis than the narrow side.

If the busbar is cut to length, a face side can also be defined to which the longitudinal axis of the busbar can substantially form the surface normal.

The busbar is made of an electrically conductive material and can be made of a metal material, for example. The busbar can be made of copper, aluminum, alloys thereof, and/or other metal materials.

In particular, the busbar can be at least partially insulated. For this purpose, the busbar is covered with a layer of a non-conductive material, such as a plastic. A lacquer coating or a similar electrically non-conductive coating is also possible.

The busbar can be at least partially coated, for example with silver, gold, nickel, and/or alloys thereof, and/or multi-layer arrangements of combinations of these metal materials, for example as a sub-nickel-plated silver coating.

The advantage of using a busbar is that it provides good conductivity for heat and electric current due to its solid construction with high cross-sections. In addition, the heat capacity is particularly good due to the volume. Due to the increased surface area compared to round conductors with the same cross-sectional surface, more heat can also be radiated via the surface.

A connection pin is arranged on the busbar. The connection pin has a joining region extending from a first front face to a center region, and a contact region extending from a second front face to the center region.

The connection pin is made of an electrically conductive material. In particular, the connection pin can be formed from a metal material, in particular copper, aluminum, alloys thereof and/or other metal materials. It is also possible to coat the connection pin at least partially or also completely. For example, the connection pin can be coated with silver, gold, nickel and/or alloys and/or combinations thereof. In particular, the connection pin can be formed from copper, in particular E-copper, and at least partially, in particular substantially completely, provided with an under-nickel-plated silver coating.

A longitudinal axis of the connection pin can also be defined, which extends, for example, along the axis of the largest spatial extension of the connection pin. A connection direction can also be defined from the joining region to the contact region.

In particular, the connection pin can be arranged in an opening in the busbar. In particular, the opening of the busbar extends from a first wide side to the opposite second wide side of the busbar. The opening can also be on one side, so that it is only accessible from a first wide side.

The connection pin can be connected to the busbar in a material-fit manner. Other types of connection are possible, for example a force-fit and/or form-fit connection. However, a material-fit connection is advantageous in terms of electrical and thermal conductivity between the connection pin and busbar.

The connection pin can be divided into two regions in particular. A joining region is connected to the busbar in the opening, in particular in a material-fit manner. For example, the connection pin can be welded to the busbar, in particular by means of a friction welding process, in particular by means of rotary friction welding.

The connection pin also has a contact region. The contact region preferably protrudes beyond a wide side in the direction of connection in the case of a connection part.

The contact region of the connection pin points away from the busbar. In particular, the contact region can be tapered, particularly with increasing distance from the busbar. In particular, a front face can be provided on the contact region of the connection pin, which points away from the busbar. The connection pin, in particular the contact region of the connection pin, can be tapered towards the front face. In particular, the contact region can be conically tapered.

The joining region and/or the contact region can at least partially have a substantially round cross-section. The joining region and/or the contact region can also have a cross-section that deviates from a round shape. For example, at least one of the regions may at least partially have a substantially oval, angular, in particular triangular, quadrangular, pentagonal or polygonal, a star-shaped or otherwise deviating from a round shape cross-section.

The busbar can be made of an electrically conductive material that is suitable for high-voltage applications and/or for carrying high direct currents. In particular, the busbar can be formed from aluminum, in particular from soft-annealed aluminum. Aluminum is lightweight, which is a great advantage for use in vehicles. In addition, aluminum is cheaper than copper. The busbar can also be formed from a different material, in particular a different metal material such as copper.

The opening of the busbar, in which the connection pin, in particular the joining region of the connection pin, is at least partially arranged, can be shaped as a through hole, for example. The through hole can have a substantially round cross-section. An elliptical, angular, in particular triangular, square, pentagonal, hexagonal, polygonal, serrated or otherwise shaped cross-section of the through hole is also possible. The through hole can have a substantially constant cross-section along the thickness of the busbar or a variable cross-section. For example, the through hole can taper towards or away from the contact region of the connection pin.

The busbar can be insulated. In particular, an insulating layer can be applied to the busbar. The insulation layer can substantially completely surround the busbar, except for regions where taps from the busbar are provided. For example, the busbar can be stripped of insulation in the region of the connection pin. Stripped does not necessarily mean that there was already insulation on the busbar that was removed. It is also possible that the busbar in the stripped region was not previously insulated.

The region of the busbar in which the connection pin is connected to it can, in particular, be an end region of the busbar. This end region can be stripped. A center tap is also possible. The busbar can be stripped in the region of the connection pin and surrounded by insulation on one or both sides of the connection pin.

The busbar can have at least one rounded corner in an end region, which can be located in particular in the region of the connection pin. Both end corners, which are visible when viewed from above on the wide side of the busbar, can also be rounded. Alternatively or additionally, the 4 corners of the end region, each of which forms a connection point between a wide side, a narrow side and the end face side of the busbar, can be rounded.

The busbar can have a cross-section of at least 50 mm², preferably between 100 and 300 mm². Larger cross-sections are also possible if a particularly high electrical power and/or a particularly large amount of heat needs to be transported.

The busbar may have a side recess in addition to the opening in which the connection pin is at least partially arranged. This side recess can be arranged on one side of the busbar so that the side recess interrupts the otherwise largely straight course of the longitudinal edge. The longitudinal edge can be defined as the edge where a wide side and a narrow side of the busbar meet. In particular, the side recess can be shaped as a notch. The edge of the side recess can extend substantially vertically from the longitudinal edge into the busbar on at least one side of the side recess when viewed from above on the wide side. Both sides of the side recess can also extend substantially vertically into the busbar. Other edge profiles on at least one side of the side recess are also possible. For example, the side recess can have one or two edges that are slanted in relation to the narrow side when viewed from above on the wide side. For example, the edges of the side recess can extend at an angle of 30-60° from the narrow side. In particular, one edge can extend substantially perpendicular and the other at an angle to the longitudinal edge. The side recess can be shaped in such a way that it forms a hook and/or an undercut in the longitudinal edge of the busbar.

The side recess can be substantially rectangular in shape, for example square. The side recess can also be rounded, for example it can be substantially semi-circular in shape. The side recess can also be shaped as a quarter circle.

A side recess can be used to lock the busbar in a holder provided for this purpose. This allows a latching element to engage in the recess. Another movable element, such as a screw element, can also engage in the side recess. Alternatively or additionally, the busbar can be encapsulated by a retaining element, for example plastic. The retaining element can engage in the side recess. In all these cases, the side recess provides the busbar with a better grip in relation to its immediate surroundings. In particular, the position of the busbar and, in particular, that of the connection pin can be clearly determined in this way by engaging in a position defined by the holder even before the connection pins make contact with elements provided for this purpose, in particular in the recess of the charging socket. In this way, the assembly of the connection element is significantly simplified.

The connection pin can be arranged centrally on the wide side of the busbar in relation to the center axis of the wide side of the busbar. When viewed from above on the wide side, the center axis can extend centrally in the wide side along the longitudinal direction of the busbar in such a manner that it is at substantially the same distance from both narrow sides. The connection pin can also be arranged decentrally in relation to the center axis of the busbar. At least the joining region of the connection pin can be located within the wide side of the busbar in a plan view of the wide side of the busbar. The joining region is preferably circumferentially surrounded by the inner lateral surface of the opening in the busbar and/or at least partially in contact therewith. The contact region of the connection pin can protrude over the wide side of the busbar when viewed from above. In an advantageous embodiment, the contact region is also located completely within the wide side in the top view of the wide side.

If the busbar has a side recess, the connection pin and side recess can be offset from one another along the longitudinal axis of the busbar. If the connection pin is in an end region, the connection pin can, for example, be offset in the direction of the end of the busbar in relation to the side recess. The connection pin can also be spaced apart along the longitudinal axis of the busbar from the end of the busbar away from the side recess. Spacing along the longitudinal axis increases the mechanical stability of the busbar, as the narrowing of the busbar due to the opening and side recess are not directly adjacent to one another. The busbar can also heat up considerably, in particular in the immediate vicinity of the connection pin, so that a lot of heat capacity is required there. For this reason, it is advantageous to distance the side recess from the connection pin. The holder, which can engage in the side recess, can also be protected from heat by spacing it from the connection pin.

The side recess and connection pin can also be substantially at the same height along the longitudinal axis of the busbar.

The connection pin can have a hole, for example a blind hole, in particular a through hole along the longitudinal axis of the connection pin. In the connected state, the through hole can be aligned substantially parallel to the surface normal on the wide side of the busbar between the connection pin and the busbar.

The through hole of the connection pin can substantially have a round cross-section. The through hole of the connection pin can also have at least partially a substantially oval, angular, in particular triangular, quadrangular, pentagonal or polygonal, a star-shaped or otherwise deviating from a round shape cross-section. A cross-section that deviates from a round shape enables a friction welding tool, for example, to transmit torque to the connection pin.

The cross-section of the through hole can be substantially constant along the longitudinal axis of the connection pin. The cross-section can also vary along the longitudinal axis. For example, the through hole may have a smaller cross-section in a region close to the contact region than in a region close to the joining region, wherein in particular the regions of different through hole cross-sections extend to the respective front faces of the joining region and contact region.

The through hole can be suitable for passing a screw through. In one embodiment, a screw can be arranged in the through hole. For example, the screw can be arranged in the through hole so that it cannot be lost, for example by inserting the screw into the through hole starting from the joining region and inserting a blocking element that can be clamped onto the screw starting from the contact region, for example a locking washer or a plastic washer with latching tabs. Here, an enlarged cross-section of the through-opening in a region close to the front face of the contact region compared to the rest of the connection pin can have an advantageous effect.

The lateral surface of the joining region of the connection pin can be substantially cylindrical in shape.

The lateral surface of the joining region of the connection pin can be at least partially connected to an inner lateral surface of the opening of the busbar in a material-fit manner. This connection can be achieved in particular during welding, in particular friction welding, in particular rotary friction welding.

The lateral surface of the contact region of the connection pin can taper, in particular in such a way that the cross-section decreases with increasing distance from the busbar. In particular, the lateral surface of the connection pin, in particular the contact region of the connection pin, can be at least partially conical in shape.

The shape of the lateral surface of the contact region can be at least partially adapted to the shape of the recess in the first front face of the plug-in pin of the charging socket. In particular, both can be conical in shape, in particular with an equal degree of tapering, so that the lateral surface of the contact region can rest substantially full-surface against the inner surface of the exception.

In an advantageous embodiment, the recess and/or the connection pin, in particular the contact region of the connection pin, is dimensioned in such a way that when the lateral surfaces of the recess and the connection pin are in contact with one another, a distance remains between the face side of the contact region and the part of the recess opposite it. This ensures that when the connection pin is screwed to the recess, the entire contact pressure is absorbed by the lateral surfaces and the connection pin can penetrate sufficiently deep into the recess so that the lateral surfaces are substantially in full-surface contact.

The joining region of the connection pin can have a smaller diameter than the opening of the busbar in which the connection pin is arranged. The two diameters can also be approximately the same size such that sufficient friction is created during friction welding. The cross-section of the joining region of the connection pin can increase at least slightly towards the contact region so that the front face on the side of the joining region can only be partially countersunk into the opening in the busbar before welding without deformation. The diameter of the joining region is therefore at least partially larger than the diameter of the opening of the busbar, in particular in a section of the joining region facing the contact region, and/or at least partially smaller than the diameter of the opening, in particular in a section facing away from the contact region. To complete the connection, welding energy can be introduced into the connection between the connection pin and the busbar, in particular by means of rotary friction welding, so that parts of the busbar and/or parts of the connection pin plasticize. The connection pin can then penetrate the busbar to the desired depth. In particular, the connection pin can penetrate at least partially into the inner lateral surfaces of the opening of the busbar radially to the longitudinal axis of the connection pin and/or be connected to them in a material-fit manner.

The contact region of the connection pin can at least partially have a larger cross-section than the opening of the busbar. In particular in the region of the transition between the joining region and the contact region of the connection pin, the contact region of the connection pin can have a larger cross-section than the opening.

The connection pin can alternatively or additionally have a collar. The collar can protrude beyond the joining region, in particular around the entire circumference of the connection pin. Optionally, the collar can also protrude radially beyond the contact region, in particular around the entire circumference of the connection pin. The collar can have a round cross-section at least in sections along the longitudinal axis. The collar of the connection pin can also have at least partially a substantially oval, angular, in particular triangular, quadrangular, pentagonal or polygonal, a star-shaped or otherwise deviating from a round shape cross-section perpendicular to the longitudinal axis of the connection pin. A cross-section of the collar that deviates from a round shape can, for example, enable a friction welding tool to transmit torque via the collar to the connection pin.

The collar can be connected to the busbar in a material-fit manner. In particular, the connection pin can be connected to the busbar with the collar alone or with the joining region in a material-fit manner.

The joining region can have a length that is greater than the thickness of the busbar. In particular, this allows the connection pin, especially the joining region of the connection pin, to protrude out of the opening in the busbar when connected. The connection pin protrudes beyond the busbar in the direction of the surface normal on the wide side, i.e. on one side with the contact region and on the other side of the busbar with the joining region extending through the opening.

The technical effect of such a protrusion on both sides can be achieved in particular in combination with a through hole in the connection pin. In particular, if a screw is guided through the through hole by means of which the connection pin is fastened to a further element, in particular in the recess of the charging socket. In this case, the contact pressure of the screw on the connection part is substantially completely absorbed by the connection pin and not substantially by the busbar.

This has the advantage, in particular with busbars made of relatively soft materials such as aluminum, that the screw connection holds permanently and does not gradually lose contact pressure due to creep processes in the busbar material. The connection pin can be made from a material such as copper, which is far less prone to deformation under permanent force than aluminum, for example.

The recess of a charging socket is the recess in a plug-in pin of a plug connector of the subject matter, which is connected to the charging socket.

Advantageously, the contact region of the connection pin is tapered in such a manner that the lateral surfaces, the outer one of the contact region of the connection pin and the inner one of the recess, rest against one another, in particular rest substantially full-surface against one another. The contact region of the connection pin can therefore be adapted to a recess. This minimizes the contact resistance between the charging socket and the connection part. In particular, the lateral surfaces can have substantially the same degree of taper. This can mean that in a side view, perpendicular to the longitudinal axis of the connection pin and/or the recess, the angle between this longitudinal axis and each of the lateral surfaces is substantially the same.

In particular, the inner lateral surface of the recess of the charging socket and/or the lateral surface of the contact region can be conically shaped. In particular, in such a manner that the lateral surfaces can rest substantially full-surface against one another.

The connection pin can be arranged in the recess. In particular, the connection pin can be connected to the recess in a force-fit and/or form-fit manner.

In particular, a screw can be passed through the connection pin, screwed into the blind hole of the receptacle and thus hold the connection pin in the receptacle.

The subject matter is explained in more detail below with the aid of a drawing showing exemplary embodiments. In the drawing:

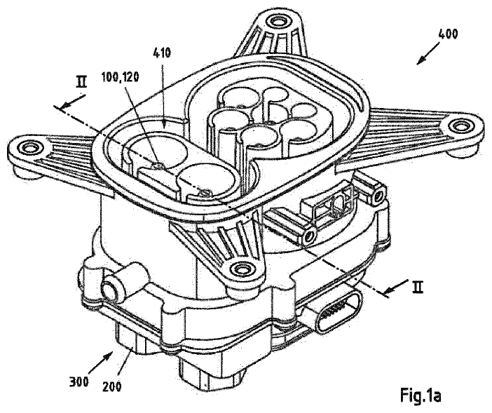

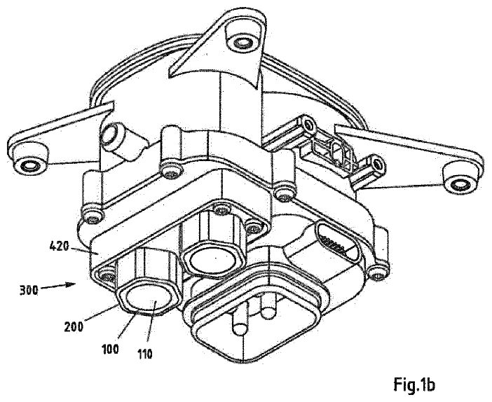

FIG. 1a,b shows an isometric view from two angles of a charging socket with plug connector according to an exemplary embodiment;

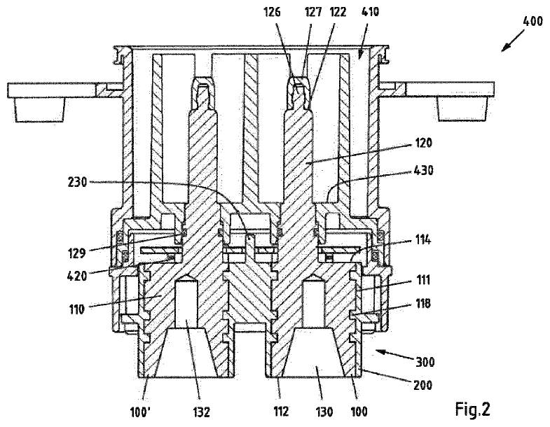

FIG. 2 shows a lateral sectional view of charging socket with plug connector according to an exemplary embodiment;

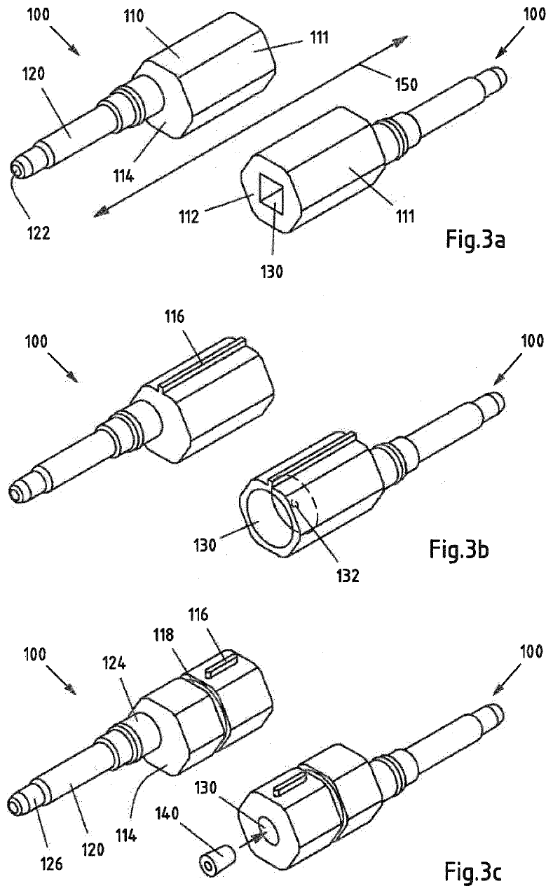

FIG. 3a-c show various plug-in pins of the subject matter in according to exemplary embodiments;

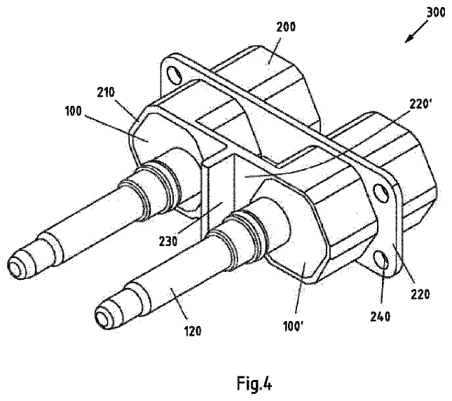

FIG. 4 shows the plug connector of the subject matter according to an exemplary embodiment.

FIG. 1a shows a charging socket 400. It comprises a receptacle 410. A plug connector 300 with two plug-in pins 100 and a housing 200 is arranged in the charging socket 400. The housing 200 can be cross-sectionally adapted to the plug connector receptacle 412. Frame surfaces 220 of the plug connector 300 can rest against the charging socket 400 and, in particular, be connected thereto. For example, these two elements can be connected to one another in a force-fit and/or form-fit manner. For example, screws as shown can hold the plug connector 300 to the charging socket 400. The second region 120 of the plug-in pin 100 protrudes into the receptacle 410. The receptacle 410 can serve to connect a charging plug, with at least one of the plug-in pins 100 serving as a contact pin for the charging plug.

The plug connector 300 can protrude from the housing of the charging socket, as shown as an example in FIG. 1b. For example, this can be realized by means of a collar 420.

FIG. 2 shows a charging socket 400 of the subject matter with a plug connector 300 in a sectional view along the sectional line III in FIG. 1a. Two plug-in pins 100, 100′ can be seen. The plug-in pins have a second region 120, a first region 110, a recess 130, as well as a front 122, a rear 112 and a further 114 front face. The recesses 118 in the lateral surface 111 can also be seen in the section. Circumferential grooves 118 are shown in the case. A blind hole 132 is arranged in the recess 130. A thickening can be seen on the second region 120 in the transition to the first region 110 of the plug-in pin 100. This thickening is shown in two stages with a first raised cross-section and a second raised cross-section. In particular, the first increased cross-section is larger than the cross-section of the remaining second region 120 in the plug-in direction, and the second increased cross-section is larger than the first increased cross-section, and thus also higher than the cross-section of the remaining second region 120 in the plug-in direction. A groove 129 is arranged around the second region 120 in the transition between the second region 120 and the first region 110. The groove can accommodate a sealing ring, for example.

The charging socket 400 further comprises a temperature sensor 420 arranged as close as possible to the further front face 114. The receptacle 410 of the charging socket 400 can also have a rear wall 430. The plug-in pins 100, 100′ can be passed through said rear wall. For example, as shown, the sealing ring can be arranged around the second region 120 between the plug-in pin 100, 100′ and the charging socket 400, in particular the base 430 of the receptacle 410 of the charging socket, in particular in an interference fit.

FIG. 3a shows a plug-in pin 100 according to an exemplary embodiment. The plug-in pin has a first region 110 and a second region 120, which are aligned along a common longitudinal axis 150. The first region 110 comprises a lateral surface 111 and a further front face 114, which points in the direction of the second region 120. The second region also comprises a front face 122.

A recess 130 is arranged at the first front face 112 of the first region 110. In the exemplary embodiment shown, the recess has an angular cross-section.

FIG. 3b also shows an exemplary embodiment of a plug-in pin 100. Compared to the plug-in pin 100 according to FIG. 1a, said plug-in pin has the special feature of a protrusion 116. The protrusion 116 extends along the longitudinal axis 150 of the plug-in pin 100. Inter alia, the protrusion 116 results in a cross-section of the first region 110 of the plug-in pin 100 that is not rotationally symmetrical (more precisely, only trivially rotationally symmetrical by 360°). A blind hole 132 is provided in the recess 130 of the plug-in pin 100 according to FIG. 1b.

Finally, FIG. 3c shows a further exemplary embodiment of a plug-in pin 100 of the subject matter. Its first region 110 has an angular outer cross-section. Said angular outer cross-section can serve, as in FIG. 1b, to prevent the plug-in pin 100 from rotating about the longitudinal axis 150 when fastened in a housing 300. The plug-in pin 100 according to FIG. 1c also has a protrusion 116 on the lateral surface 111 of the first region 110. The plug-in pin 100 also has a groove 118 in the lateral surface 111, which is designed in particular to be circumferential and extends over the entire circumference of the lateral surface 111. The second region 120 is provided with a thickening 114 towards the first region. This can be conducive to stability. A groove is provided there, for example for a sealing ring. A guide tip 126 is arranged on the second face side 122 of the plug-in pin 100. An element 140 can be inserted into the recess 130. This can be, for example, a pin 140 adapted to the shape of the recess 130, which is equipped with a through hole, for example. For example, a screw can be inserted into the blind hole 132 through this through hole. The pin 140 can be fastened using the blind hole 132.

Finally, FIG. 4 shows an exemplary embodiment of a plug connector 300 of the subject matter.

In this embodiment, the latter comprises two plug-in pins 100, 100′. The second regions 110 of which have a non-rotationally symmetrical cross-section. The plug-in pins are arranged in receptacles 210, 210′ of a housing 200. The housing 200 surrounds the lateral surfaces 111 of the plug-in pins 100, 100′.

The housing 200 shown herein is not designed in a solid manner. Instead, the plug-in pins 100, 100′ are each enclosed by a housing layer on their lateral surfaces 111, 111′. In addition, frame surfaces 220, 220′ are provided. Said frame surfaces are aligned perpendicular to the longitudinal axis 150 of the plug-in pins 100, 100′. The frame surface 220′ is arranged in the region of the further front face 114 of the first region 110. In particular, the frame surface 220′ is arranged flush with the further front face 114 of at least one of the two plug-in pins 100, 100′. The frame surface 220′ is provided with a further frame surface 230, which is aligned parallel to the longitudinal axis 150 of the two plug-in pins 100, 100′, and is arranged between the two plug-in pins 100, 100′, in particular between the two second regions 120. The frame surface 220 protrudes beyond the rest of the housing 200 (excluding the frame surface 220) perpendicular to the longitudinal direction of the plug-in pins 100, 100′. The frame surface 230 protrudes in the longitudinal direction, more precisely in the plug-in direction, beyond the rest of the housing. Four holes 240 can be seen, which can be used for assembly. For example, screws can be passed through these holes.

1. A plug connector, comprising:
at least one plug-in pin, wherein the plug-in pin has a first region extending from a first front face to a center region, and a second region extending from a second front face to the center region,
wherein
the plug-in pin has a recess tapering towards the center region on its first front face and
a blind hole with a thread is arranged in the recess of at least one of the at least one plug-in pin.

2. (canceled)

3. The plug connector according to claim 1,
wherein the at least one plug-in pin
comprises at least two plug-in pins.

4. The plug connector according to claim 1,
wherein
the second region of at least one of the plug-in pins has a smaller cross-section than the first region.

5. (canceled)

6. (canceled)

7. The plug connector according to claim 3,
wherein
the center axis of the second region of at least one of the plug-in pins is arranged eccentrically with respect to the center axis of the first region of the at least one plug-in pin, so that the center axes of the second regions of the at least two plug-in pins are at a smaller distance from one another than the center axes of the first regions of the at least two plug-in pins.

8. The plug connector according to claim 1,
wherein
at least one of the recesses is conical in shape.

9. The plug connector according to claim 1,
wherein
the recess of at least one of the plug-in pins is arranged eccentrically to the center axis of the first region of the at least one plug-in pin in the first front face of the metal connector.

10. The plug connector according to claim 1,
wherein
the second region of at least one plug-in pin is adjacent to a further front face of the first region of the plug-in pin which is different from the first front face and which faces the second region.

11. (canceled)

12. (canceled)

13. The plug connector according to claim 1,
wherein
at least one of the plug-in pins is made of a conductive material, in particular metal, in particular aluminum and/or copper.

14. The plug connector according to claim 1,
wherein
at least one of the plug-in pins is at least partially coated, in particular with silver, gold and/or nickel, in particular with a lower coating of nickel and an upper coating of silver applied to the lower coating.

15. The plug connector according to claim 1,
wherein
the first region and/or the second region of at least one of the plug-in pins has at least one protrusion and/or indentation, in particular an at least partially circumferential groove.

16. (canceled)

17. The plug connector according to claim 1,
wherein
the cross-section of the first region of at least one of the plug-in pins deviates at least partially from a round cross-section, in particular is elliptical, triangular, square, polygonal, star-shaped, or otherwise shaped, in particular such that the cross-section is not invariant to rotations about the longitudinal axis of the plug-in pin and/or is only invariant to rotations about a limited set of angles.

18. The plug connector according to claim 1,
wherein
the cross-section of the second region of at least one of the plug-in pins at the transition between the first and the second region is increased in relation to the remaining cross-section of the second region, in particular at least one indentation, in particular an at least partially circumferential groove, is arranged on the second region in the region of the transition.

19. The plug connector according to claim 1,
wherein
a screw can be inserted through the recess into the blind hole and fastened there.

20. (canceled)

21. (canceled)

22. (canceled)

23. (canceled)

24 (canceled)

25. (canceled)

26. (canceled)

27. (canceled)

28. (canceled)

29. A charging socket with a front side and a rear side facing away from the front comprising:
a receptacle for a charging plug arranged on the front,
a plug connector according to claim 1, which is arranged at least partially within the receptacle and extends from the front side to the rear side,
wherein the first region extends from the rear side in the direction of the receptacle and the second region extends into the receptacle.

30. The charging socket according to claim 29,
wherein
the charging socket comprises retaining means for the plug connector.

31. A system comprising a charging socket according to claim 29, wherein the plug connector is connected to the charging socket in a force-fit and/or form-fit manner, and/or the second region of at least one of the plug-in pins of the plug connector is arranged at least partially in the receptacle of the charging socket, and/or the first front face of at least one of the plug-in pins protrudes from the charging socket along the longitudinal direction of the plug-in pin.
